(19) United States
(12) Patent Application Publication
(10) Pub. No.: US 2005/0013418 A1
(43) Pub. Date: Jan. 20, 2005

(54) Emergency notification systems

(76) Inventors: Shye-Bin Chang, Naperville, IL (US); Richard H. Hemmeter, Naperville, IL (US)

Correspondence Address: Law Office of Peter V.D. Wilde, 301 East Landing, Williamsburg, VA, 23185, US

(21) Appl. No.: 10/620,162

(22) Filed: Jul. 15, 2003

(51) Int. Cl. H04M 11/04

(52) U.S. Cl. 379/45; 379/49

(57) ABSTRACT

The specification describes an emergency notification system (ENS) that is integrated with an existing telephone network. The ENS comprises a central emergency coordination center (CECC) that receives information specific to the nature and location of an emergency event, and selects one or more regional emergency coordination center(s) (RECCs) based on the location and nature of the emergency. The RECC selects a list of telephone numbers of customers potentially affected, calls those numbers, and transmits the emergency message. The calls are preferably initiated using a distinctive ring pattern. Techniques for overcoming answering machine interruption are disclosed. Embodiments where the customer is provided with means for detecting the distinctive ring pattern of the ENS, and the detection means directly activates an intrusive alarm or loudspeaker are also disclosed.

### FIELD OF THE INVENTION

This invention relates to emergency notification systems (ENS), and more particularly, to notification systems with wide area alerting and messaging capabilities.

### BACKGROUND OF THE INVENTION

A variety of emergency notification systems have been proposed, and several are in general use. Loudspeaker systems are commonly used in buildings or campuses to warn local occupants of emergency conditions. These have message capability, but are effective over a limited area, and are initiated by more or less random access to local events and authorities. Regional alerts to emergency conditions can be effected by sirens operated by regional governments or the Federal Emergency Management Agency (FEMA). FEMA also has an emergency notification system operated through television networks. In combination, these provide an effective means for alerting large numbers of affected persons, and conveying suitable messages to them. However sirens have limited effectiveness, and the television messaging system only reaches people who are viewing at the moment of the alert.

With the advent of terrorism in the United States, and the prospect of public disaster on a wide regional scale, renewed attention is being given to improving emergency notification systems that effectively alert large numbers of people, and provide emergency messages to them.

### BRIEF STATEMENT OF THE INVENTION

We have designed an ENS that currently has the potential to operate over the entire United States, allows effective alerting of large numbers of people in a selected local or wide area, and has messaging capability. It relies on the existing installed telephone network, and thus covers more than 90% of the general population of the United States. The ENS operates through a central ENS coordinating office (local, regional, or national) that initiates the alert/notification, and broadcasts or multicasts instructions to regional centers, or to local exchange switching centers. The instructions include data identifying the area affected, or the customer base affected. The instructions may also identify one or more existing stored message programs at the regional node, or may provide a message. The regional node then initiates telephone calls to selected, potentially-affected, customers to provide the message to the selected customers. In some cases, that may include all of the customers in the region. In a preferred case, the ENS of the invention employs a characteristic telephone ring to alert the customer to an emergency. The characteristic ring is especially effective for alerting at night when people are sleeping.

### BRIEF DESCRIPTION OF THE DRAWING

The invention may be better understood when considered in conjunction with the drawing in which:

FIG. 1 is a schematic diagram of an ENS telephone network;

FIG. 2 is a schematic representation of ring patterns useful in the system of FIG. 1;

FIG. 3 is a circuit diagram of a ring pattern detector (RPD).

### DETAILED DESCRIPTION OF THE INVENTION

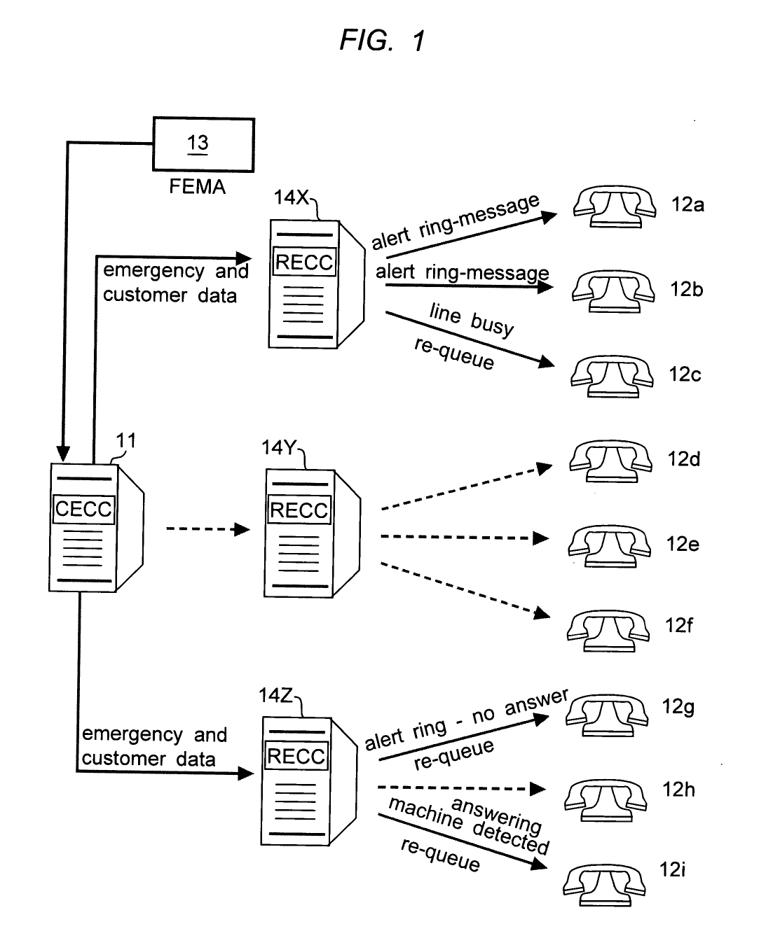

The ENS of the invention relies on a central emergency coordination center (CECC), represented by computer 11 in FIG. 1. Typically, this center will be operated by, or in conjunction with, a regional or national authority, such as FEMA. The CECC receives information from a local or regional government authority, represented by box 13 and identified in this embodiment as FEMA, on common disasters affecting, or potentially affecting, large numbers of customers. The information sources will typically comprise local fire and police authorities, civil defense authorities, FEMA, Homeland Security officials, and the like. The system may also be extended to include emergency warnings about natural disasters such as tornados and floods, in which case the authority 13 may comprise the National Weather Bureau. Biological or disease related emergency information might originate from the CDC in Atlanta. In each case, the information given to the CECC will identify the nature of the emergency and the geographical area affected. The CECC communicates emergency information to regional emergency coordination centers (RECCs), shown at 14X, 14Y, and 14Z in FIG. 1. In the example shown, RECCs 14X and 14Z have been selected based on the information input to the CECC. RECC 14Y is has no customers involved. There are several options available for coordinating information between the CECC and the RECCs. These will be described in more detail below. Important ingredients of the information relayed from the CECC to the RECCs include a specific identification of the nature of the emergency (event information) and a specific identification of the area or customers affected (customer information). As described below, customer information may be specific customer identity, group customer identity, or just geographic location data. Eventually the initial geographic location data will be refined to specific customer identification. That function may be performed in whole or part at the CECC, or at the RECC.

The RECCs are typically local switching centers that access groups of customers. In the illustration in FIG. 1, RECC 14X serves customers 12a, 12b, and 12c; RECC 14Y serves customers 12d, 12e, and 12f; and RECC 14Z serves customers 12g, 12h, and 12i. When the RECC receives emergency information from the CECC, it identifies customers potentially affected, calls those customers, and transmits an emergency message. In FIG. 1, the customers selected as residing in the affected disaster area are customers 12a, 12b, 12c, 12g, and 12i. As illustrated, customers 12a and 12b have been alerted, and the emergency message delivered. The telephone of customer 12c is shown as busy, in which case the call is re-queued for later. Customers 12d, 12e, 12f and 12h have been identified by the RECC as not affected, and are not called. Customer 12g has been called, but no answer received. That customer is re-queued to be called later. Customer 12i has been called, but an answering machine has been detected. The call to customer 12i is re-queued to repeat the alert ring.

In the illustration there are N users, where N=9. It should be obvious that in an actual telephone network, hundreds or thousands of customers will be served by switching centers 14X, 14Y, and 14Z, and that the network system comprises many more switching centers than shown. In the preferred system embodiment, the CECC 11 has access to all switching centers nationwide. It will also be understood that the RECCs described herein are the existing switching centers in the telephone network. Additional switching facilities may or may not be added to implement the invention. While the amount of outgoing information in the ENS, in the form of event information, may be large and nearly simultaneous, it is distributed. Where the data stream from the CECC to the RECC is abbreviated by using stored programs at the RECC, congestion at the CECC is minimized. Congestion at the customer location does not occur.

As indicated above, several options exist for implementing the invention. These share the common feature of a national CECC communicating emergency information and area affected to designated RECC(s), and the designated RECC(s) communicating emergency information to the customers identified as potentially affected. In one embodiment, the emergency information comprises both: 1. an emergency alert, in the form of a unique telephone ring pattern, and 2. a voice message giving emergency information.

For effective operation of an ENS system as described, it is important for the system to identify initially at least a subset of customers potentially affected (the subset identification may or may not include specific customer data). This function is desirably performed at the CECC. Implementing this aspect, the CECC is provided with a look-up table with customer identification, or customer group identification, correlated with geographic location. In a simple case, broad scale correlation is already available in the form of area codes, or local exchange numbers. Regional telephone companies also have groupings of local exchange numbers that are used for billing intra-LEC calls. Any of these options may be used. For more precise area/customer correlation, new stored programs may be developed. In the ENS shown in FIG. 1, the CECC 11 is provided with a suitable correlation table. The information exchanged between the CECC and a selected RECC includes both the nature of the emergency, and customer data to allow identification of customers potentially affected. It may include data for the entire subgroup of customers affected, i.e. specific customer/location correlation data, with the specific customer lists being stored at the CECC, or the CECC may only identify a selected subgroup. In the latter case the specific customer list for the subgroup identified is stored at the RECC, minimizing the volume of data to be sent from the CECC and reducing the potential for network congestion. The RECC then initiates calls to the selected customers. These calls are preferably initiated using the distinctive ring pattern described in more detail below. It may be useful to queue calls to subgroups of selected customers to avoid system overload, i.e. call 20% of the customer list, then 20% more, and so on.

In another ENS implementation, the CECC processes only geographic location information sufficient to select one or more RECCs, and all of the location/customer correlation is performed by the RECC. However, even in this case, there is a gross correlation between the RECCs identified and the customer location simply by virtue of the regional geographic nature of the network. Therefore the term customer information is used here and below as defining customer information having a location content. An example of this would be the selection of one or more central offices (typically RECCs) based on emergency location information received by the CECC. When the emergency location information is received by the RECC it is correlated with specific customer information to generate a specific list of telephone numbers corresponding to customers affected.

In a generic sense the CECC transmits emergency location information to the RECC in the form of either the location of the emergency event (e.g., Three Mile Island Nuclear Power Plant), or the location of subsets of customers (e.g.,Area Codes 717, 610), or local exchange numbers (e.g. 717-240,245,291,783,541), or specific customer lists.

Similar system options are available in choosing the site where the emergency message content originates. Prerecorded messages may be used, or messages may be recorded that are specific to a given event. Where pre-recorded messages are used, the RECC may be provided with a stored program of messages, and the CECC only identifies a code designating the nature of the event or the appropriate message. In most cases the CECC will identify the event as well as the customer sets (for example, area code), or customer lists, involved. To reduce the data load on the CECC, as much information as possible may be stored at the RECC.

Where more than one RECC is involved, the event information may be multicast. The event information exchanged between the RECC and the customers may also be multicast. Multicasting is used in a variety of network environments where information is exchanged using data packets, and wherein the data packets from a main centralized server (CECC) may be routed from the CECC to regional centers (RECCs) or from a RECC to many customers. In essence, multicasting allows a centralized server, CECC or RECC, to send each information packet once for transport over the wider area network, with multicast routers being used to make copies of the program stream for each local user port that is identified by the ENS. If an emergency message is brief, which is ordinarily desirable, the multicast signal may continuously repeat the message. This allows the customer to answer the ring alert at a random point in the message. The multicast message from the CECC to one or more RECCs will be set to automatically connect when initiated, so that multicasting between these nodes is straightforward.

As described earlier, the invention in the preferred embodiments employs a unique ring pattern as an initial alerting device. The effectiveness of the unique telephone ring pattern stems from the fact that customers who are accustomed to a normal ring pattern, e.g., uniform rings of 2 seconds, and uniform silence of 4 seconds, are easily alerted when the ring pattern deviates significantly. Normal ring patterns may be ignored. A specific problem arises when the customer uses a device, such as an answering machine, to screen calls (this is discussed in more detail below). However, an anomalous ring pattern will provide an effective alert in nearly all situations.

Distinctive ring patterns have been used for caller ID, and services using them are available commercially. Distinctive ringing is also used commonly in PBXs to discriminate calls from inside a building from those originating outside. See for example, U.S. Pat. No. 4,995,075, issued Feb. 19, 1991.

For caller ID, several ring patterns may be used. However, In implementing some embodiments of the invention it is preferred that the network provide only two, or a limited number, of ring patterns, so that the emergency ring pattern of the invention remains distinct and readily identifiable.

Ringing circuits commonly used in the United States are usually designed to operate at 20 Hz, but can use any frequency between 15 and 68 Hz. This suggests the possibility of implementing the invention using different ring frequencies (as contrasted with patterns). The ring frequency used for normal calls may be 20 HZ, while a higher frequency is used as the ring for the emergency alert. The term distinctive ring, as used herein, is intended to cover both distinctive ring patterns and distinctive ring frequencies, in each case being different from the ring for normal calls.

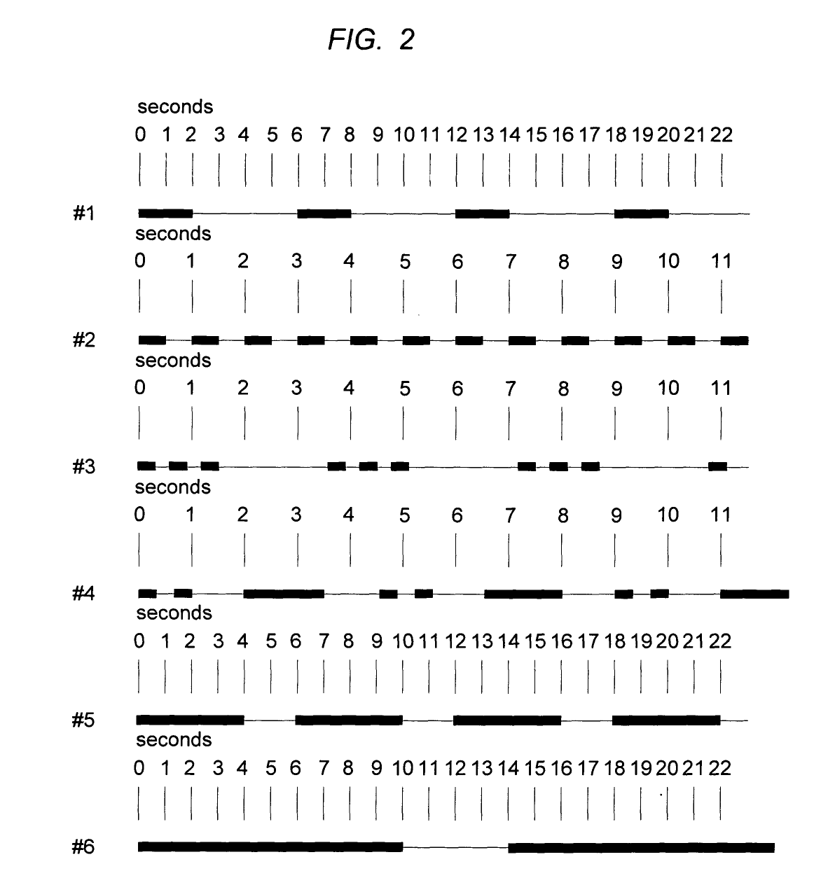

The conventional ring pattern, and some potentially useful ENS ring patterns, are shown schematically in FIG. 2. A conventional ring pattern is represented by pattern #1. This ring pattern has approximately two seconds on and four seconds off. A ring pattern that is considered distinctive from #1 is shown as #2. This pattern has short rings of approximately 0.5 seconds on and approximately 0.5 seconds off. Another distinctive ring pattern, #3, has three short rings at 2 second intervals. Ring pattern #4 has rings with different durations, i.e. short rings of less than one half second alternating with a longer ring, here shown as 1.5 seconds. Ring pattern #5 has relatively long rings of approximately 4 seconds, and ring pattern #6 has very long rings of approximately 10 seconds. Long ring patterns, such as #6, may be especially useful for subverting answering machine interruption. For example, if an answering machine is set to pick-up after four rings, ring pattern #5 will continue for 22 seconds before pick-up. Ring pattern #6 will continue for nearly a minute before pick-up. However, long rings consume power from the central office, and in the application described are not preferred. Very short ring patterns, such as #2, #3, and #4, are expected to be most effective as ENS alert rings when used with normal ring patterns with approximately 2 second rings. In general, it is preferred that the ring duration for the ENS alert ring is 50% or less of the ring duration for normal rings. Answering machine interruption when using short ring patterns will be treated in more detail below.

The ring patterns shown in FIG. 2 have a regular cadence, and rings in ring patterns 1, 2, 3, 5, and 6 are of uniform duration. Ring pattern 4 has rings of varying duration, and this embodiment may be preferred from the standpoint of alert effectiveness. Also, ring patterns 1, 2, 5, and 6, have on/off repeating units that are the same. Ring patterns 3 and 4 have on/off repeating units that are different. The latter may also be preferred.

Typical telephone ring circuits have a 75 V AC ringing current, with a minimum for ring detection of approximately 40 V. In modern telephones, the ringing current operates an electronic ringing chip or chip segment connected to a small speaker. The AC ringing current passes a capacitor which blocks the DC voice signal. Details of telephone ringing circuits are well known. See, for example, U.S. Pat. No. 4,866,587, entitled Electronic Ringing Signal Generator, and U.S. Pat. No. 4,025,729, entitled Telephone Ringing Control Circuits, which are incorporated herein by reference.

As mentioned earlier, a potential problem with ENS networks is the widespread use of answering machines and the possibility that the answering machine will pick-up too soon during the ENS ring alert, e.g. before an effective alert can be broadcast at the customer premises. For example, if the alert ring pattern is #2 in FIG. 2, an answering machine set to pick-up after three rings will terminate the alert ring after only 2 seconds (even less in the case of ring pattern #3).

There are several options for overcoming this. One has already been mentioned, i.e. the use of long ring patterns. However, if short ring patterns are preferred for the alert ring, other options are available. A tone detector circuit may be inserted in the line (at the RECC) to detect the answering machine tone that invites the caller to leave a message. Alternatively, a speech recognition circuit may be connected to the line and programmed to detect characteristic words, such as “you”, “reached”, “message”, that are used frequently in a machine answering message. An alternative approach is to detect the cadence or duration of the answering greeting phrase. If a brief phrase is detected (as in the case of “hello”) followed by a brief silence interval (for example, 2 seconds), connection to a human is assumed and the emergency message played. If the answering greeting phrase continues for more than the programmed time (2 seconds), the off-hook is presumed to be caused by an answering device or service. In these cases, if an answering machine is detected in response to a pick-up after the alert ring, the call may be automatically re-queued and the alert ring repeated. In some cases it may be preferred that the emergency message be recorded on the answering machine on the first detection of the answering machine tone, i.e. prior to re-queuing the call. The number of repeat rings may be automatically set at 5, for example, so that futile calls are not repeated indefinitely. Alternatively, a declining number of calls could be re-attempted until all were successfully delivered or the emergency was canceled by the RECC. For customers whose numbers had been re-queued because of answering machine detection , busy status, “ring, no answer” status, etc., the ENS would make subsequent attempts once all customers had received an initial alerting attempt.

The ENS RECC would provide tracking and administration of the list of subscribers to be alerted. As shown in FIG. 1, the ENS would recognize whether an alerting call had reached the intended subscriber, had not been answered, or was answered by an announcement machine or automated service. The ENS would remove subscribers from the active alerting list as they are successfully contacted while re-queuing those which did not reach a human subscriber. The ENS re-queues each called destination until a human subscriber is successfully alerted or the emergency event is officially canceled The ENS records these results to support any subsequent analysis of the effectiveness of the ENS.

Use of the invention in conjunction with special telephone attachments is also contemplated. Embodiments where the station set at the customer premises is modified, or a special “box” provided, will be given by way of example. These also rely on the basic ENS networks described earlier, and the distinctive emergency alert ring pattern.

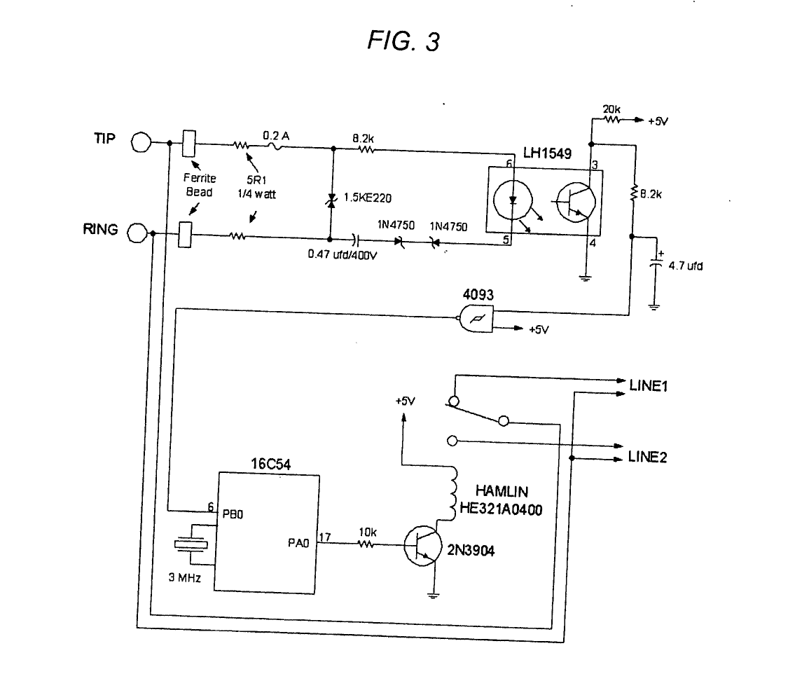

A ring pattern detector (RPD) may be used at the customer location. The RPD is designed to detect the ENS ring pattern. The advantage of this embodiment is that it avoids interference from an answering device, and is virtually “fail safe”. With a properly chosen ring patterns, the detection device detects the ENS alert ring before the answering machine responds. If the detection device detects the normal ring cadence, the detection device does not respond and ringing continues in the normal way, or the answering machine answers in the normal way. If an ENS alert ring is detected by the detection device, any of several operations may be triggered. For example, the detection device may operate a relay that activates an alarm installed at the customer location. The alarm performs the alert function and prompts the customer to answer the telephone and hear the emergency message. The incoming call may be switched to a loudspeaker device at the customer location, and the emergency message broadcast over the loudspeaker. Speakers may be installed at various locations at the customer's location including bedrooms. It may also be convenient to incorporate an RPD in an answering machine and program the answering machine to respond with a loud alert and/or a loud message. RPD devices useful for this application are described in more detail at http://www.analogservices.com/phone.htm, and available from Analog Services, Inc., Edina, Minn. A typical RPD circuit is shown in FIG. 3. The switch works by measuring time intervals. A normal ring pattern, e.g. ring pattern #1 in FIG. 2, is 2 seconds on and 4 seconds off. Ring pattern #2 has 0.5 seconds on, and 0.5 seconds off. Therefore, a ring pattern that has a ring that is on for more than 1 second (normal) is distinguishable from the ENS alert pattern where the ring is on for less than one second. The RPD can therefore detect the ENS alert after only one or two rings, i.e. in less than two seconds.

In the circuit shown, for reliable operation, the switch ignores the first ring and begins its measurements on the second one. The incoming line is always connected to one or the other of the output lines. Once a decision is made and the relay is opened or closed, it is simply left in this state until the next ring cadence. On power up the relay is open. Because the switch in this example requires at least two rings before it makes a decision, connected devices such as answering machines should be programmed to require 4 rings.

The ENS described so far include emergency messages as well as alert signals (distinctive ring patterns). In a simpler embodiment of an ENS, the system uses just an emergency alert signal. Customers may be informed that upon receipt of the emergency alert signal, they take some pre-arranged action, for example, turn on channel 5 of your television receiver. The system may be designed with a simple interconnection and relay between the telephone and television to automatically perform this step. Thus it will be appreciated that the basic ingredient of the ENS in many cases is the emergency alert signal, with or without emergency message capability.

In its most basic configuration, the ENS advantageously operates using only power supplied by the local switching center. The fundamental ENS alerting service is delivered and powered wholly from the local switching center, which includes reliable back up power. Thus, ENS can provide its primary function even in the event that power is not available at the subscriber premises. Such local loss of power can be expected in many emergency situations and precludes use of radio, TV, internet, and other broadcast or distribution systems that rely on local electrical power.

A large number of network configurations may be envisioned to implement the ENS of the invention. Typically these will include the CECC and one or more RECCs as described above. They may include in addition, one or more nodes more central to the CECC. For example, all system alerts may originate from a national ECC, which authorizes alerts for several or many CECCs. The ENS network may also have nodes located between the CECC and the RECC for authorizations, network administrative functions, etc.

The term distinctive ring pattern as used herein and below is intended to define the case wherein the network initiates normal calls to the customers affected using a first telephone ringing pattern, and the telephone calls of the ENS have a second ringing pattern.

Various additional modifications of this invention will occur to those skilled in the art. All deviations from the specific teachings of this specification that basically rely on the principles and their equivalents through which the art has been advanced are properly considered within the scope of the invention as described and claimed.

1. A method for emergency notification over a telephone network wherein the emergency notification is initiated by emergency event information and emergency location information, the steps comprising;
a. processing at a central emergency coordination center (CECC) the emergency location information by comparing the emergency location information with a stored look-up program,
b. identifying one or more regional emergency coordination centers (RECCs) at the emergency location,
c. transmitting emergency location information from the CECC to the RECC,
d. transmitting emergency event information from the CECC to the RECC,
e. in response to step c., selecting a list of telephone numbers of customers affected,
f. using the list of step e., initiating customer telephone calls from the RECC to receivers of the customers affected,
g. in response to step d. transmitting emergency event information to receivers of the customers affected.

2. The method of claim 1 wherein the stored look-up program in step a. comprises geography data.

3. The method of claim 1 wherein the stored look-up program in step a. comprises specific customer information.

4. The method of claim 1 wherein step e., the step of selecting comprises generating a list of customer telephone numbers.

5. The method of claim 1 wherein the network initiates normal calls to the customers affected using a first telephone ringing pattern, and the telephone calls in step. f are initiated using a second ringing pattern.

6. The method of claim 5 wherein the second ringing pattern comprises rings having a duration of less than 50% of those in the first ringing pattern.

7. The method of claim 1 wherein the call initiated in step f. is answered by an answering machine and the RECC detects the answering machine.

8. The method of claim 5 wherein the receivers detect the second ringing pattern using a ringing pattern detector (RPD).

9. The method of claim 8 wherein the (RPD) activates an alarm in response to detecting the second ringing pattern.

10. The method of claim 1 wherein the RECC records the response to the telephone calls made and re-queues selected calls for a repeat call.

11. The method of claim 10 wherein the response is selected from the group consisting of no answer, busy, and answering device.

12. A method for emergency notification over a telephone network wherein the emergency notification is initiated by emergency location information, the steps comprising;
a. processing at a central emergency coordination center (CECC) the emergency location information by comparing the emergency location information with a stored look-up program,
b. identifying one or more regional emergency coordination centers (RECCS) at the emergency location,
c. transmitting emergency location information from the CECC to the RECC,
d. in response to step c., selecting a list of telephone numbers of customers affected,
f. using the list of step d., initiating customer telephone calls from the RECC to receivers of the customers affected, the telephone calls comprising a distinctive ring pattern.

13. An emergency notification system comprising a telephone network wherein the emergency notification is initiated by emergency event information and emergency location information, comprising;
a. a central emergency coordination center (CECC),
b. means associated with the CECC for receiving the emergency event information and the emergency location information,
c. a stored program in the CECC for correlating emergency location information with telephone customer location information and identifying one or more regional emergency coordination centers (RECCs) at the emergency location,
d. means for transmitting emergency location information from the CECC to the RECC,
e. means for transmitting emergency event information from the CECC to the RECC,
f. means for generating a customer list of telephone numbers of customers affected,
g. means for generating an emergency message,
h. means for initiating emergency telephone calls from the RECC to receivers of the customers affected,
i. means for transmitting the emergency message to receivers of the customers affected.

14. The system of claim 13 wherein the stored program comprises geography data.

15. The system of claim 13 wherein the stored program comprises specific customer information.

16. The system of claim 13 wherein the customer list is generated by the RECC.

17. The system of claim 13 further including network means for initiating normal calls to the customers affected with a first telephone ringing pattern, and means for initiating the emergency calls to the customers affected with a second ringing pattern.

18. The method of claim 17 wherein the second ringing pattern comprises rings having a duration of less than 50% of those in the first ringing pattern.

19. The system of claim 13 further including a ringing pattern detector (RPD) connected to the receivers to detect the second ringing pattern.

20. The system of claim 19 including means in the RPD for activating an alarm in response to detecting the second ringing pattern.
